(19) United States
(12) Patent Application Publication
(10) Pub. No.: US 2024/0346771 A1
(43) Pub. Date: Oct. 17, 2024

(54) METHOD AND APPARATUS FOR MARKING VIRTUAL OBJECT, TERMINAL, AND STORAGE MEDIUM

(71) Applicant: Tencent Technology (Shenzhen) Company Limited, Shenzhen (CN)

(72) Inventor: Huifei BAO, Shenzhen (CN)

(21) Appl. No.: 18/756,442

(22) Filed: Jun. 27, 2024

Related U.S. Application Data
(63) Continuation of application No. PCT/CN2023/097348, filed on May 31, 2023.

(30) Foreign Application Priority Data
Jul. 26, 2022 (CN) 202210887870.X

(51) Int. Cl. G06T 19/00; G06F 3/01

(52) U.S. Cl. CPC G06T 19/00; G06F 3/016

(57) ABSTRACT

This application discloses a method for marking a virtual object performed by a computer device. The method includes: receiving a touch operation for a virtual object; displaying a marking mode prompt in accordance with a current force of the touch operation, the marking mode prompt indicating a marking mode currently used for marking the virtual object at the current force; and rendering a multi-modal marking on the virtual object in response to an end signal for the touch operation, when the marking mode is a target marking mode. Efficiency of marking the virtual object in the human-computer interaction is improved in the solutions in the embodiments of this application.

### CROSS-REFERENCE TO RELATED APPLICATIONS

This application is a continuation application of PCT Patent Application No. PCT/CN2023/097348, entitled “METHOD AND APPARATUS FOR MARKING VIRTUAL OBJECT, TERMINAL, AND STORAGE MEDIUM” filed on May 31, 2023, which claims priority to Chinese Patent Application No. 202210887870.X, entitled “METHOD AND APPARATUS FOR MARKING VIRTUAL OBJECT, TERMINAL, AND STORAGE MEDIUM” filed on Jul. 26, 2022, both of which are incorporated herein by reference in their entirety.

### FIELD OF THE TECHNOLOGY

Embodiments of this application relate to the field of human-computer interaction, and specifically, to a method and an apparatus for marking a virtual object, a terminal, and a storage medium.

### BACKGROUND OF THE DISCLOSURE

In most multiplayer online games, for example, a massive multiplayer online (MMO) game and a multiplayer online battle arena (MOBA) game, a multiplayer team game is core gameplay, and players need to cooperate through real-time communication.

In the related art, manners in which the players send interaction information are mainly text input, tapping on a mark interaction control, tapping on a mini map of a virtual environment, dragging and sending a mark, and the like. In the foregoing manners, an interactive operation procedure is complex, and interaction efficiency is low. In addition, a mark control needs to occupy a specific screen position., causing space waste.

### SUMMARY

Embodiments of this application provide a method and an apparatus for marking a virtual object, a terminal, and a storage medium, which can simplify an operation procedure of a user marking the virtual object, and improve marking efficiency. The technical solutions are as follows.

According to an aspect, an embodiment of this application provides a method for marking a virtual object performed by a computer device, the method including:
receiving a touch operation for a virtual object;
displaying a marking mode prompt in accordance with a current force of the touch operation, the marking mode prompt indicating a marking mode currently used for marking the virtual object at the current force; and
rendering a multi-modal marking on the virtual object in response to an end signal for the touch operation, when the marking mode is a target marking mode.

According to another aspect, an embodiment of this application provides a computer device, the computer device provides a processor and a memory, the memory storing at least one program, and the at least one program, when executed by the processor, causing the computer device to implement the method for marking the virtual object according to the foregoing aspect.

According to another aspect, an embodiment of this application provides a non-transitory computer-readable storage medium, the computer-readable storage medium storing at least one program, and the at least one program, when executed by a processor of a computer device, causing the computer device to implement the method for marking the virtual object according to the foregoing aspect.

In this embodiment of this application, the computer device receives a touch operation for a virtual object, and detects press force of the touch operation to display a corresponding marking mode prompt based on the press force of the touch operation and a mapping relationship between the press force and a marking mode, to prompt a current marking mode to a user. In addition, when the touch operation ends in the target marking mode, the terminal marks the virtual object by using the target marking mode, and completes the marking. In the solutions provided in the embodiments of this application, in a process in which a single touch operation is performed on the virtual object, the press force of the touch operation is controlled to implement different manners for marking the virtual object. Therefore, a marking procedure of the virtual object is simplified, and marking efficiency of the virtual object is improved.

In addition, because a marking control does not need to be set additionally in an interface, a development difficulty and development complexity of an application interface can be reduced, and a mis-touching probability of the control can be reduced through the application interface having low content complexity. Therefore, waste of processing resources caused by mis-touching the control is avoided.

### BRIEF DESCRIPTION OF THE DRAWINGS

FIG. 1 is a schematic diagram of an implementation environment according to an exemplary embodiment of this application.

FIG. 2 is a flowchart of a method for marking a virtual object according to an exemplary embodiment of this application.

FIG. 3 is a mapping relationship diagram between press force and marking modes according to an exemplary embodiment of this application.

FIG. 4 is a flowchart of a complex marking method according to an exemplary embodiment of this application.

FIG. 5 is a schematic diagram of a control menu according to an exemplary embodiment of this application.

FIG. 6 is a schematic diagram of an operation of a complex marking method according to an exemplary embodiment of this application.

FIG. 7 is a flowchart of a local marking method according to an exemplary embodiment of this application.

FIG. 8 is a flowchart of an operation of a local marking method according to an exemplary embodiment of this application.

FIG. 9 is a schematic diagram of a position priority of an object control according to an exemplary embodiment of this application.

FIG. 10 is a flowchart of a customization method for a marking purpose according to an exemplary embodiment of this application.

FIG. 11 is a schematic diagram of an operation of a customization method for a marking purpose according to an exemplary embodiment of this application.

FIG. 12 is a schematic diagram of a condition for switching a marking mode according to an exemplary embodiment of this application.

FIG. 13 is a schematic diagram of a dynamic marking mode according to an exemplary embodiment of this application.

FIG. 14 is a schematic diagram of an operation of a dynamic marking method according to an exemplary embodiment of this application.

FIG. 15 is a structural block diagram of an apparatus for marking a virtual object according to an exemplary embodiment of this application.

FIG. 16 is a structural block diagram of a terminal according to an exemplary embodiment of this application.

### DESCRIPTION OF EMBODIMENTS

To make the objectives, technical solutions, and advantages of this application clearer, the following further describes embodiments of this application in detail with reference to the accompanying drawings.

Terms involved in the embodiments of this application are described below.

Virtual environment: It is a virtual environment displayed (or provided) when an application runs on a terminal. The virtual environment may be a simulated environment of the real world, may be a semi-simulated and semi-fictional environment, or may be a purely fictional environment. The virtual environment may be any one of a two-dimensional virtual environment, a 2.5-dimensional virtual environment, or a three-dimensional virtual environment. This is not limited in this application.

Virtual object: It is an interactive object in the virtual environment. The virtual object may be a virtual character, such as a virtual human, a virtual animal, or an animation character. The virtual character is a three-dimensional model created based on a skeletal animation technology. The virtual object may alternatively be a virtual item, a virtual position, or the like in the virtual environment, for example, a plant, an oil drum, a wall, or a stone displayed in the virtual environment. Each virtual object has a shape and a volume in a three-dimensional virtual environment, and occupies a part of space in the three-dimensional virtual environment.

In some embodiments, the virtual character may be a user character controlled through operations on a client, may be an artificial intelligence (AI) character set in a fight in a virtual scene through training, may be a non-player character (NPC) set in the virtual scene, or certainly, may be a building, an item set, an item box, or the like set in the virtual scene. In some embodiments, the virtual character may be a virtual character for battle in the virtual scene. In some embodiments, a quantity of virtual characters participating in interaction in the virtual scene may be preset, or may be dynamically determined based on a quantity of clients participating in the interaction.

Virtual battle: It is a game battle in which at least two virtual objects fight in the virtual environment. In some embodiments, the virtual battle is a single-round battle in which at least two virtual characters fight. In some embodiments, the virtual battle may be a virtual battle in a single-player matching mode (that is, the virtual characters in the virtual battle fight alone), a virtual battle in a dual-player matching mode (that is, the virtual characters in the virtual battle may fight in a two-player team, or may fight alone), or a virtual battle in a multiplayer matching mode (that is, at most four or five virtual characters may form a team for fighting in the virtual battle). When a matching mode is the dual-player matching mode or a four-player matching mode, a first virtual character may be matched with a second virtual character in a friend relationship, or may be matched with a third virtual character not in a friend relationship. In some embodiments, when the matching mode is the dual-player matching mode or the multiplayer matching mode, virtual characters that are teammates may communicate with each other by sending text information, or a virtual mark may be sent to implement information interaction.

Mark: It is an information mark set by a player for a target virtual character, a target virtual item, or a target position in the virtual battle. The mark is configured for the player to perform human-computer interaction and perform real-time interaction between users during the virtual battle, to implement tactics information communication. In some embodiments, the mark may be used in the virtual battle in the single-player matching mode, or may be used in virtual battle in the multiplayer mode such as the dual-player matching mode or the four-player matching mode. In some embodiments, the mark may be a mark performed by the player on a target virtual object, or may be strategic information sent by the player to all teammates or some teammates, such as “assemble” or “attack”. The strategic information may be for a specific position, a specific virtual character, or the virtual item in the virtual environment.

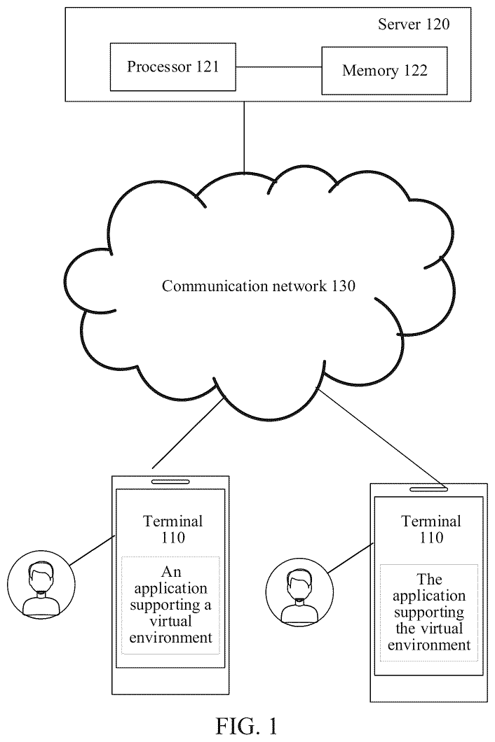

FIG. 1 is a schematic diagram of an implementation environment according to an exemplary embodiment of this application. The implementation environment includes a terminal 110, a server 120, and a communication network 130.

An application supporting a virtual environment is installed and run on the terminal 110. The application may be any one of a virtual reality application, a simulation game (SLG), a three-dimensional map program, a first-person shooting (FPS) game, or a MOBA game. A user uses the terminal 110 to control a virtual object located in the virtual environment to perform an operation. The operation includes, but is not limited to, at least one of obtaining revenue, upgrading, fighting, switching equipment, or construction. In addition, the user uses the terminal to perform the operation in the application. For example, the virtual object is a virtual character, such as a simulation character object or an animation character object, or the virtual object is a virtual item. The terminal 110 may generally refer to one of a plurality of terminals. The terminal 110 is merely used as an example for description in the embodiment. A device type of the terminal 110 includes at least one of a smartphone, a tablet computer, an e-book reader, an MP3 player, an MP4 player, a laptop computer, or a desktop computer. An example in which the terminal includes the smartphone is used for description in the following embodiments.

In this embodiment of this application, the terminal 110 may detect press force of a touch operation, so that object marking in different manners is implemented based on different press force.

In some embodiments, the terminal 110 is equipped with a vibration motor, so that different degrees of vibration feedback may be provided for the touch operation with different press force.

The terminal 110 is connected to the server 120 through the communication network 130 such as a wireless network or a wired network.

The server 120 includes at least one of a server, a plurality of servers, a cloud computing platform, or a virtualization center. For example, the server 120 includes a processor 121 and a memory 122, and is configured to provide a background service for an application supporting a three-dimensional virtual environment. In some embodiments, the server 120 undertakes primary computing work, and the terminal 110 undertakes secondary computing work; or the server 120 undertakes secondary computing work, and the terminal 110 undertakes primary computing work; or a distributed computing architecture is used between the server 120 and the terminal 110 to perform collaborative computing.

A person skilled in the art may learn that there may be more or fewer terminals. For example, there may be only one terminal, or there may be dozens or hundreds of terminals, or more terminals. A quantity and the device type of the terminal are not limited in the embodiments of this application.

In the related art, the user may communicate with teammates by sending text information in a chatting region. However, in this manner, that the user invokes a keyboard may occupy a part of a screen, and may block an interface of the virtual environment. In addition, an operation of inputting text interrupts a game operation of the user. Therefore, an application scenario is limited. A marking control is displayed on a part of a game interface. The user may tap on the marking control to send preset marking information to the teammates. However, in this manner, a mark may be only displayed at a position of a virtual object of the user, and a virtual mark having a position attribute cannot be sent. In addition, some games support the user in sending the preset marking information by tapping on a mini map of the virtual environment. In other words, the user may tap on a target position to the teammates in a thumbnail display region in which a global virtual environment and positions of all virtual objects are displayed, to send marking information displayed at the target position. However, in this manner, the user cannot select content of the marking information, and the content provided by an algorithm may not match intention of the player. In addition, when a device screen used by the user is limited, and an area of the thumbnail display region is small, precision of a position selected by the user is limited. In the related art, the user may alternatively drag a field of view to select a marking target, and perform a sliding operation to send the marking information. However, in this manner, the user needs to adjust a center position of the field of view to determine a marking position, a plurality of operations is usually needed, and accuracy is not high.

In this embodiment of this application, the user may participate in a virtual battle through a battle program. The battle program may be a game application, such as a MOBA game application, a shooting game application, or a survival game application. This is not limited in this embodiment of this application. In the virtual battle, the user may directly perform the touch operation on the virtual object to mark the virtual object. In addition, the user may perform a plurality of different marking operations through the touch operation with different press force. In this solution, the marking operation is simple and intuitive. A difficulty of the marking operation is reduced, and the accuracy of the marking operation is improved.

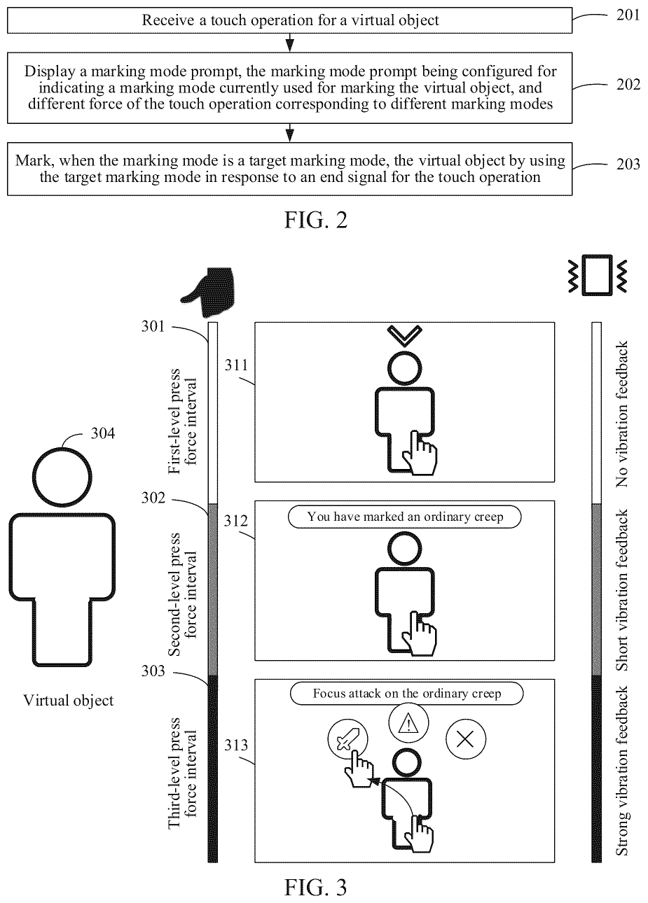

FIG. 2 is a flowchart of a method for marking a virtual object according to an exemplary embodiment of this application. The method for marking a virtual object provided in the embodiments of this application is described with reference to FIG. 2 and the foregoing application scenario. In this embodiment, the method is applied to a terminal for description. The method includes:

Operation 201: Receive a touch operation for the virtual object.

In this embodiment of this application, when the terminal is in a marking state, the terminal receives the touch operation for the virtual object, and uses the operation as a marking operation. In some embodiments, the terminal may enter the marking state by receiving a touch operation for a marking state control. The marking state control is a control displayed on an interface of a virtual scene, and is configured to control the marking state on and off.

In another possible implementation, a marking press threshold is set on a terminal. When press force of the touch operation is less than the marking press threshold, it is determined that the terminal is in a non-marking state. When the press force of the touch operation is greater than the marking press threshold, it is determined that the terminal is in the marking state, and the touch operation is determined as the marking operation. This omits an operation of the user triggering the marking state control.

In a possible implementation, the terminal receives the touch operation performed by the user at a display position of the virtual object, and detects the press force of the touch operation. A manner in which the terminal detects the press force of the touch operation may be that a pressure sensor is arranged below a touch panel, and the terminal senses a change of self-sensing capacitance through a capacitance module in the pressure sensor, to determine a position and force of pressing, such as a force touch technology or a 3D press technology. In the foregoing technology, based on different touch panels of the terminal, the terminal may alternatively sense the press force by tiny electrodes arranged around the touch panel.

In some embodiments, the terminal may detect a contact area between a finger of the user and the touch panel when the touch operation is performed, and determine the press force of the touch operation based on a mapping relationship between the contact area and the press force. The press force is positively correlated with the contact area. The foregoing manner in which the terminal detects the press force of the touch operation is merely used for description. This is not limited in this embodiment of this application.

The virtual object may be a virtual character in a virtual battle, a virtual item (such as a virtual vehicle, a virtual supply, or a virtual tool) in the virtual environment, a virtual position in the virtual environment, a virtual building, or the like. This is not limited in this embodiment of this application.

Operation 202: Display a marking mode prompt, the marking mode prompt being configured for indicating a marking mode currently used for marking the virtual object, and different force of the touch operation corresponding to different marking modes.

Based on the touch operation with different press force, the terminal enters the different marking modes. In the different marking modes, the terminal marks the virtual object in different manners. In other words, the user may control the press force of the touch operation to mark the virtual object in different manners, to reduce a mis-operation of the user, and improve marking accuracy.

In addition, to make the user clearly sense a current marking mode, the terminal displays the marking mode prompt based on that the terminal is currently in the marking mode, to prompt the user for the marking mode corresponding to current press force.

In a possible implementation, at the different press force, the terminal displays different marking mode prompts. Differences between the different marking mode prompts may lie in at least one of a prompt manner or prompt prominence.

For example, the different marking mode prompts may use a same prompt manner but have different prompt prominence, or the different marking mode prompts use different prompt manners and have different prompt prominence, or the different marking mode prompts use different prompt manners but have same prompt prominence.

In some embodiments, the prompt manner includes at least one of a text prompt, an animation prompt, or a special effect prompt.

In some embodiments, the prompt prominence is related to at least one of a prompt display position, whether the prompt is highlighted, a prompt display size, or prompt duration. In a possible implementation, the terminal stores a correspondence between a press force interval, the prompt manner, and the prompt prominence. The terminal determines a target prompt manner and target prompt prominence based on the press force interval to which the press force of the touch operation belongs and from the correspondence, and then displays the marking mode prompt based on the target prompt manner and the target prompt prominence.

Certainly, in another possible implementation, the terminal may alternatively store a correspondence between different marking modes and marking mode prompts. After determining the marking mode based on the press force, the terminal further determines the marking mode prompt corresponding to the marking mode based on the correspondence, and displays the marking mode prompt.

In this embodiment of this application, the terminal sets a plurality of levels of press force intervals for the touch operation. For example, the terminal determines that the press force is in a first-level press force interval when the press force is in a range of 0 N to 1 N, the press force is in a second-level press force interval when the press force is in a range of 1 N to 3 N, and the press force is in a third-level press force interval when the press force is in a range of 3 N and above. The terminal is triggered, based on the press force interval of the press force of the touch operation, to enter the corresponding marking mode by the touch operation.

In this embodiment of this application, differences between different marking manners lie in at least one of operation complexity, a marking conveying object, and a conveying situation of a marking purpose.

In some embodiments, the operation complexity is related to at least one of operation duration, operation trajectory complexity, and an operation manner (such as tapping, long-pressing, and long-press sliding).

In some embodiments, the marking conveying object includes at least one of a user character, some ally characters, all ally characters, some enemy characters, and all enemy characters.

In some embodiments, the conveying situation of the marking purpose includes whether the marking purpose is supported to be sent to the marking conveying object, and when the marking purpose is supported to be sent to the marking conveying object, complexity of a conveyed marking purpose may be further included. The marking purpose may include positioning, assembling, attacking, and the like. This is not limited in this embodiment.

In some embodiments, for the marking manners having different complexity, the marking mode may be divided into a simple marking mode and a complex marking mode. To match user experience of the operation, the terminal may establish a mapping relationship between the first-level press force interval and the second-level press force interval that have small press force, and the simple marking mode; and establish a mapping relationship between the third-level press force interval with large press force and the complex marking mode. When the terminal is in the different marking modes, the user may implement different marking manners through the touch operation. The marking manner may be divided into a simple marking manner and a complex marking manner based on different marking mode complexity, or the marking manner may be divided into a local marking manner, a partial marking manner, and a global marking manner based on different marking synchronization objects.

In some embodiments, the simple marking mode may be further divided into multiple levels of marking modes, and the complex marking mode may also be further divided into multiple levels of marking modes. Different levels of marking modes correspond to different press force intervals. For example, the simple marking mode includes a first marking mode and a second marking mode, and the complex marking mode includes a third marking mode and a fourth marking mode; or the simple marking mode includes a first marking mode and a second marking mode, and the complex marking mode includes a third marking mode; or the simple marking mode includes a first marking mode, and the complex marking mode includes a second marking mode and a third marking mode.

For example, as shown in FIG. 3, when the press force of the touch operation applied to a virtual object 304 is in a first-level press force interval 301, corresponding to a first marking mode 311, the terminal displays an “arrow” icon above a target virtual object of the touch operation, to prompt the user that the terminal is in the first marking mode 311 currently. When the press force of the touch operation is in a second-level press force interval 302, corresponding to a second marking mode 312, the terminal displays a “prompt banner” in the virtual scene, to prompt the user that the terminal is in the second marking mode 312 currently. When the press force of the touch operation is in a third-level press force interval 303, corresponding to a third marking mode 313, the terminal displays a control menu in the virtual scene, to prompt the user that a marking manner corresponding to the third marking mode 313 may be implemented at current press force. The foregoing content of the marking mode prompt is merely used for description. This is not limited in this application.

Operation 203: Mark, when the marking mode is a target marking mode, the virtual object by using the target marking mode in response to an end signal for the touch operation.

The target marking mode is a marking mode in which the touch operation ends. Corresponding to different target marking modes, the terminal marks the virtual object in different marking manners. In a possible implementation, the terminal determines a target marking manner corresponding to the current marking mode in response to the end signal for the touch operation, and then marks the virtual object in the target marking manner.

In conclusion, in this embodiment of this application, a terminal receives a touch operation for a virtual object, and detects press force of the touch operation to display a corresponding marking mode prompt based on the press force of the touch operation and a mapping relationship between the press force and a marking mode, to prompt a current marking mode to a user. In addition, when the touch operation ends in the target marking mode, the terminal marks the virtual object by using the target marking mode, and completes the marking. In the solutions provided in the embodiments of this application, in a process in which a single touch operation is performed on the virtual object, the press force of the touch operation is controlled to implement different manners for marking the virtual object. Therefore, a marking procedure of the virtual object is simplified, and marking efficiency of the virtual object is improved.

In the marking state, the terminal enters the marking mode in response to the touch operation. The terminal determines the current marking mode based on the press force of the touch operation, and the press force for triggering to enter the simple marking mode is less than press force for triggering to enter the complex marking mode.

In this embodiment of this application, the touch operation may trigger the terminal to enter the different marking modes, to implement different manners for marking. Marking complexity of a plurality of marking modes is different, and the marking complexity is reflected in the complexity of the marking manner performed by the terminal when the terminal is in the marking mode, and whether the marking can convey the marking purpose (or the complexity of the marking purpose that can be conveyed).

For example, when being in the simple marking mode, the terminal may perform simple marking such as selection on the virtual object in response to the end signal for the touch operation. When being in the complex marking mode, the terminal may display a plurality of selection controls of candidate marking purposes indicating different marking purposes, and perform complex marking including the marking purpose on the virtual object in response to the end signal for the touch operation.

In some embodiments, the terminal may establish a mapping relationship between the press force interval and the marking mode based on that the press force is positively correlated with the complexity, to adapt to a user operation habit. For example, the user may trigger the terminal to enter the simple marking mode through the touch operation with first-level press force.

In a possible implementation, after receiving the touch operation, the terminal determines the press force of the touch operation. A manner in which the terminal determines the press force of the touch operation is the same as the manner described in operation 202. Details are not described in this embodiment. The terminal determines the current marking mode based on the mapping relationship between the press force and the marking mode. To conform to the user operation habit, the user may control the terminal to enter the simple marking mode by performing the touch operation with small press force. In addition, when the user performs the touch operation with large press force, the terminal enters the complex marking mode in response to the operation. The simple marking mode and the complex marking mode indicate different marking manners, and one marking mode may correspond to a plurality of marking manners. In this embodiment of this application, as shown in FIG. 3, when the press force of the touch operation is in the first-level press force interval 301, the touch operation triggers the terminal to enter the first marking mode 311. Correspondingly, when the press force of the touch operation is in the second-level press force interval 302, the touch operation triggers the terminal to enter the second marking mode 312. Both the first marking mode 311 and the second marking mode 312 are the simple marking modes. When the press force of the touch operation is in the third-level press force interval 303, the touch operation triggers the terminal to enter the third marking mode 313, and the third marking mode is the complex marking mode.

When the current marking mode belongs to the simple marking mode, a manner in which the terminal marks the virtual object is described by using the following exemplary embodiment.

A simple marking mode prompt is displayed when the current marking mode belongs to the simple marking mode. The simple marking mode is a marking mode that does not support conveying a marking purpose.

In some embodiments, the press force of the touch operation is positively correlated with the complexity of the marking mode. The simple marking mode includes the first marking mode and the second marking mode. From the foregoing embodiments of this application, the terminal determines the marking mode based on the press force of the touch operation, and the different marking modes correspond to the different marking manners. However, in an actual implementation, the user cannot directly determine the current marking mode based on the touch operation performed. To prompt the user that simple marking can be implemented through the current touch operation, the terminal displays the simple marking mode prompt.

In a possible implementation, when the marking mode belongs to the simple marking mode, a marking effect preview is performed based on a marking manner corresponding to the current marking mode. As shown in FIG. 3, in response to that the press force of the touch operation is in the first-level press force interval 301, the terminal enters the first marking mode 311, and displays the “arrow icon” at the position of the virtual object, to prompt the user that the terminal is in the first marking mode currently. In response to that the press force of the touch operation is in the second-level press force interval 302, the terminal enters the second marking mode 312, and displays the “prompt banner” in the virtual scene, to prompt the user that the terminal is in the second marking mode currently. The foregoing manner of the marking mode prompt is merely used for description. This is not limited in this application.

Because the simple marking mode is the marking mode that does not support conveying the marking purpose, none of manners of the simple marking mode prompt includes content of the marking purpose. The marking purpose reflects an interaction purpose of the user. For example, the marking purpose may be “assemble”, or “attack”.

In the simple marking mode, in response to the end signal for the touch operation, the terminal marks the virtual object in the corresponding simple marking manner. A marking manner corresponding to the simple marking mode includes the local marking manner and the global marking manner. The marking of the virtual object in the local marking manner is locally applied, and the marking of the virtual object in the global marking manner is synchronized to another virtual character in a same team.

The local marking manner means that a server only sends a virtual mark to a corresponding terminal of the user that performs the touch operation. The global marking manner means that the server sends the mark of the virtual object to the terminal corresponding to all virtual characters in an ally team, to synchronize the mark with all the virtual objects in the ally team.

In a possible implementation, based on that the terminal is currently in the first marking mode, the terminal selects the virtual object in response to a stop signal of the touch operation, that is, the terminal marks the virtual object in the local marking manner. Based on that the terminal is currently in the second marking mode, the terminal performs conventional marking on the virtual object that does not have the marking purpose, and in response to the stop signal of the touch operation, the terminal displays a marking success prompt, and displays a marking icon at a display position of the virtual object. In this case, in some embodiments, the terminal may mark the virtual object in the local marking manner, or may synchronize the mark to all the virtual objects in the ally team, and perform global marking.

In a possible implementation, the terminal prompts the user that the corresponding mark is completed through vibration feedback. The terminal performs the vibration feedback based on a feedback manner corresponding to the target marking mode. The vibration degree of the vibration feedback is positively correlated with press force for triggering to enter the target marking mode. The terminal classifies the press force into three levels, and correspondingly sets three different vibration feedback manners. As shown in FIG. 3, in response to that marking is completed in the first marking mode 311, the terminal does not vibrate. In response to marking is completed in the second marking mode 312, the terminal feeds back to the user with short vibration.

In the virtual battle, in addition to a selection operation and the simple marking, real-time information interaction is generally needed between players to implement strategic communication. In a corresponding scenario, the user expects to convey the marking purpose to the virtual character in the same team through marking, so that another virtual character performs the corresponding operation based on the marking purpose.

For example, when the player needs the another virtual character to cooperatively attack an enemy virtual character “character A” in the game, the user expects to convey a marking purpose of “attacking the character A” to the another virtual character through marking. In this case, the user may convey the marking purpose through complex marking. When the terminal is in the complex marking mode, to avoid mis-operation by the user, the terminal may inform the user of the current marking mode by displaying the complex marking mode prompt.

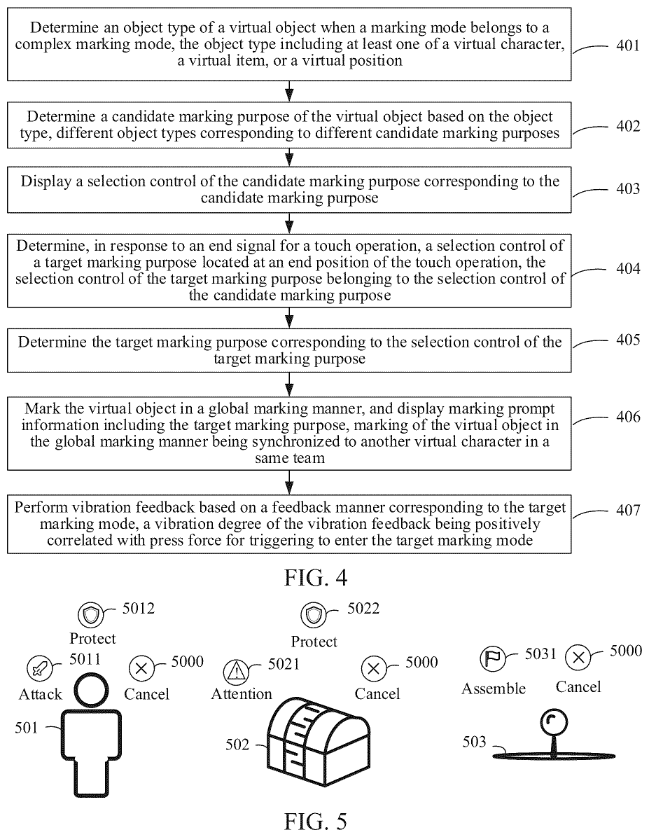

The complex marking mode prompt includes the plurality of selection controls of the candidate marking purposes, and the user may select a corresponding control to perform a marking operation including the marking purpose on the virtual object. When the current marking mode belongs to the complex marking mode, a manner in which the terminal marks the virtual object is described by using the following exemplary embodiment. FIG. 4 is a flowchart of a complex marking method according to an exemplary embodiment of this application. That the method is applied to the terminal shown in FIG. 1 is used as an example for description, and the method may include the following operations.

Operation 401: Determine an object type of a virtual object when a marking mode belongs to a complex marking mode, the object type including at least one of a virtual character, a virtual item, or a virtual position.

In a possible implementation, in the complex marking mode, the terminal displays a control menu. The control menu displays a plurality of selection controls of candidate marking purposes, so that a user selects a selection control of a target marking purpose from the control, to implement the target marking purpose. In other words, in the complex marking mode, the user may select a marking purpose. During a battle, when the user marks different types of virtual objects, the marking purpose of the user is always different. Therefore, the terminal needs to determine the object type of the virtual object corresponding to a touch operation.

In a possible implementation, the terminal determines the object type of the virtual object based on the virtual object displayed at a position of the touch operation. The object type is at least one of the virtual character, the virtual item, or the virtual position.

A MOBA game is used as an example, as shown in FIG. 5, when the virtual object is a virtual object that can perform an adversarial action, the terminal may determine that the virtual object is a virtual character 501. The virtual character may be a virtual character controlled by another user, such as a “teammate” or an “enemy” of the virtual character controlled by the user, or may be an AI virtual character controlled by the terminal, such as an “ordinary creep” and an “epic creep”. When the virtual object is a virtual object that provides virtual gain for the virtual character controlled by the user, and the virtual object does not perform the adversarial action, for example, a “treasure box”, the terminal may determine that the virtual object belongs to a virtual item 502. When the virtual object is only a virtual object that is not movable and cannot provide the virtual gain in a virtual scene, such as “grass” or a “building”, the terminal may determine that the virtual object belongs to a virtual position 503.

When determining the object type, the terminal may further divide the virtual object based on a team to which the virtual object belongs based on determining that the virtual object belongs to the virtual character, the virtual item, or the like. For example, the MOBA game is used as an example. For the virtual character controlled by the user in a same team, the terminal may determine that the virtual object belongs to an ally virtual character. For the virtual object controlled by the user in an opposing team, the terminal may determine that the virtual object belongs to an enemy virtual character. Similarly, for the virtual object controlled by the terminal such as a “creep” displayed in a map range in an ally team, the terminal may determine that the virtual object belongs to the ally virtual character.

Operation 402: Determine a candidate marking purpose of the virtual object based on the object type, different object types corresponding to different candidate marking purposes.

For the virtual object belonging to the different object types, the user has different marking purposes when perform marking. The terminal determines a corresponding candidate marking purpose based on the object type of the virtual object.

In a possible implementation, the terminal may establish a mapping relationship between the object type and the marking purpose. In the complex marking mode, the terminal determines, based on the object type of the virtual object corresponding to the touch operation and through the mapping relationship, that a marking purpose corresponding to a current object type is the candidate marking purpose.

As shown in FIG. 5, the terminal may establish a mapping relationship between an object type “virtual character” and marking purposes such as attack 5011 and protect 5012. For an object type “virtual item”, the terminal may establish a mapping relationship between the object type “virtual item” and marking purposes such as attention 5021 and protect 5022. For an object type “virtual position”, the terminal may establish a mapping relationship between the object type “virtual position” and marking purposes such as assemble 5031. To simplify an operation process of the user exiting the marking mode, the terminal may display a cancel control 5000 in the control menu, so that the user ends current marking.

In an illustrative example, the MOBA game is used as an example. When the user marks the virtual character in the ally team, the terminal determines that the object type of the virtual character is an “ally virtual character”. Then, the terminal determines, based on a correspondence between the object type and the marking purpose, that the candidate marking purpose includes protection and assembling. In addition, when marking the virtual character in the enemy team, the terminal determines that the object type of the virtual character is an “enemy virtual character”, and the terminal determines that the candidate marking purpose includes attack and attention.

In some embodiments, a correspondence between the virtual object type and the candidate marking purpose may be customized by the user. The server may provide materials for the candidate marking purpose, and then, the candidate marking purpose of the corresponding object type is set by the user. The candidate marking purpose may be any combination of material provided by the server.

Operation 403: Display the selection control of the candidate marking purpose corresponding to the candidate marking purpose.

In the complex marking mode, the terminal displays the control menu, so that the user selects a marking selection control corresponding to an expected marking manner from the control menu. The terminal determines, based on the touch operation, a marking purpose that may be expected by the user, namely, the candidate marking purpose, so that the terminal determines the selection controls of the candidate marking purposes corresponding one-to-one to the candidate marking purposes, and displays the selection control of the candidate marking purpose on the control menu. When a selection menu of the candidate marking purpose is displayed, a cancel control is further displayed on the control menu, so that the user can exit the complex marking mode.

In a possible implementation, the terminal determines the material for the selection control of the candidate marking purpose, and there may be one or more selection controls of the candidate marking purpose.

In an illustrative example, the MOBA game is used as an example. As shown in FIG. 3, when the user performs the touch operation at a display position of the virtual character controlled by the user in the enemy team, the terminal determines that the virtual object belongs to the “enemy virtual character”. Then, the terminal determines, based on the mapping relationship between the object type and the candidate marking purpose, that the candidate marking purpose is the attack and the attention. Further, the terminal determines that an attack control and an attention control are the selection control of the candidate marking purpose. The terminal further forms the selection control of the candidate marking purpose and the cancel control into the control menu, and displays the control menu at the position of the virtual object.

Operation 404: Determine, in response to an end signal for the touch operation, a selection control of a target marking purpose located at an end position of the touch operation, the selection control of the target marking purpose belonging to the selection control of the candidate marking purpose.

The terminal displays the control menu including the selection control of the candidate marking purpose at a position corresponding to the touch operation. The user implements the corresponding marking method by selecting the selection control of the candidate marking purpose in the control menu. A manner in which the user selects the control of the marking purpose may be that a position of the touch operation is moved to a display position of the selection control of the candidate marking purpose when the press force of the touch operation is maintained. The terminal determines, in response to that the touch operation ends at the display position of the selection control of the candidate marking purpose, that the selection control of the candidate marking purpose is the selection control of the target marking purpose.

In a possible manner, when the user performs the touch operation, and the press force of the touch operation is in the third-level press force, the terminal displays, based on that the terminal is currently in the complex marking mode, the “touch menu” at the display position of the virtual object. The “touch menu” includes the plurality of selection controls of the candidate marking purposes. When maintaining the current press force, that is, when maintaining the press force at the third-level press force, the user moves a touch position to the display position of the selection control of the candidate marking purpose in the control menu, and ends the touch operation at the current position. In response to the end signal of the touch operation, the terminal determines the selection control of the candidate marking purpose at the end position of the touch operation, and determines that the control is the selection control of the target marking purpose.

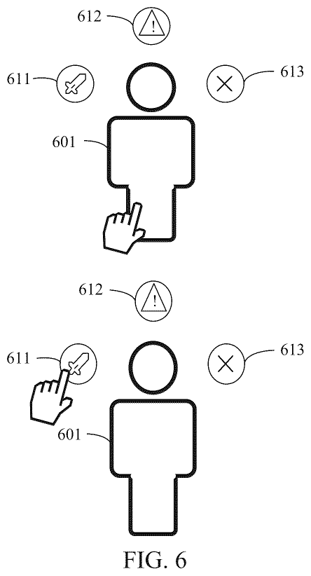

In an illustrative example, the MOBA game is used as an example. The user expects to mark the enemy “character” to inform the teammate to help to attack the “character”. As shown in FIG. 6, the user performs the touch operation at a display position of a virtual character 601 controlled by a user in an enemy team. Press force of the touch operation reaches the third-level press force. The terminal enters the complex marking mode, determines that a virtual object 601 is an “enemy virtual character”, and determines a selection control of a candidate marking purpose, so that the terminal displays a control menu including an attack control 611, an attention control 612, and a cancel control 613. The user may move the touch position to a display position of the attack control 611 when maintaining the press force, and end the touch operation at the foregoing position. In response to an end signal of the touch operation, the terminal determines that the attack control is a selection control of a target marking purpose of the current touch operation.

In some embodiments, in another possible manner, in the complex marking mode, the user may switch a target marking virtual object by changing a position of the touch operation. The user may move, when maintaining the press force, the position of the touch operation from a display position of a first virtual object to a display position of a second virtual object. When touch duration of the touch operation reaches a time threshold, the terminal displays a replacement control at the position of the second virtual object, so that the user switches the target marking virtual object from the first virtual object to the second virtual object.

In an illustrative example, the MOBA game is used as an example. In the battle, when a remaining capability value of an ally “character A” is low, to inform other users in an ally team to protect the character A, the user performs the touch operation with the press force that reaches the third-level press force at a display position of the ally virtual object “character A”, and invokes the control menu including the protection control. In this case, when the remaining capability value of the “character A” has decreased to 0, and a remaining capability value of an ally virtual object “character B” is low, that is, the user expects that the target marking virtual object is switched from the “character A” to the “character B”, the terminal may detect that the position of the touch operation is changed, and the position of the touch operation is maintained at a display position of the “character B” for the time threshold. A change control is displayed at the display position of the “character B”.

In a virtual battle, the virtual character is a movable virtual object. When the user performs the touch operation on the virtual character, in response to that the touch operation triggers the terminal to enter the complex marking mode, the terminal displays a control menu at the position of the virtual object. If the position of the virtual character moves, a display position of the control menu remains unchanged. In addition, the terminal may still complete marking of the virtual object based on an operation such as the user subsequently selecting the selection control of the candidate marking purpose.

Operation 405: Determine a target marking purpose corresponding to the selection control of the target marking purpose.

In the complex marking mode, the user may convey a marking purpose by performing the touch operation, to implement information interaction in the battle.

In a possible implementation, the terminal may determine the corresponding target marking purpose based on the selection control of the target marking purpose, that is, determine information expected to be conveyed through marking by the user. For example, the terminal may determine, based on that the selection control of the target marking purpose is the protection control, that the target marking purpose is information for “protecting” the virtual object conveyed to the teammate.

Operation 406: Mark the virtual object in a global marking manner, and display marking prompt information including the target marking purpose, marking of the virtual object in the global marking manner being synchronized to another virtual character in a same team.

The global marking manner is a marking operation that the terminal synchronizes the mark to all virtual objects in the ally team based on the touch operation performed by the user, and the marking prompt information of the target marking purpose is displayed.

In a possible implementation, the terminal synchronizes the marking manner corresponding to the target marking purpose to all virtual characters in the same team, so that the terminal displays the target mark at the position of the virtual object based on the target marking manner.

In an illustrative example, the MOBA game is used as an example. The same team includes five players. The user marks all the “character A” through the touch operation. The terminal determines, based on the selection control of the target marking purpose, that the target marking purpose is “protection”. In addition, the terminal sends the target marking purpose to five terminals of all users in the ally team. After receiving the target marking purpose sent by the terminal, the terminal performs protection marking on the virtual object, and displays the marking prompt information including “protection”. Therefore, another user views the protection mark and the prompt information displayed in the terminal, and can learn that support needs to be provided in time to protect the ally “character A”, to quickly implement information interaction between teammates in this case.

Operation 407: Perform vibration feedback based on a feedback manner corresponding to the target marking mode, a vibration degree of the vibration feedback being positively correlated with press force for triggering to enter the target marking mode.

In some embodiments, in the complex marking mode, in response to completing marking in a third marking mode, the terminal feeds back to the user with intense vibration.

In conclusion, in the complex marking mode, a terminal user may invoke the control menu through the touch operation with the press force that reaches the third-level press force, and then, performs a marking operation in which the marking manner is optional on the virtual object. For the control menu including the selection control of the candidate marking purpose and the cancel control, the user may select the selection control of the target marking purpose by changing the position of the touch operation, that is, the user may mark the virtual object only through one consecutive touch operation. This simplifies a procedure of the marking operation, and improves marking efficiency.

In addition, in this embodiment of this application, the touch operation is directly performed at the display position of the virtual object, and there is no need to add additional controls. This saves a display region of the terminal.

When the user completes the complex marking, the terminal feeds back to the user, through strong vibration, that the complex marking operation is completed. This reduces a mis-operation rate of the user.

Based on the foregoing embodiments, in response to the end signal for the touch operation, the terminal synchronizes the marking of the virtual object to the another virtual character in the ally team. In a possible situation, the user only expects some virtual characters to respond to the mark. When the mark is synchronized to all virtual characters, another user is usually needed to determine, based on experience, whether to respond to the mark. There is a deviation between a decision result and a subjective purpose of the user. Therefore, interaction efficiency is affected.

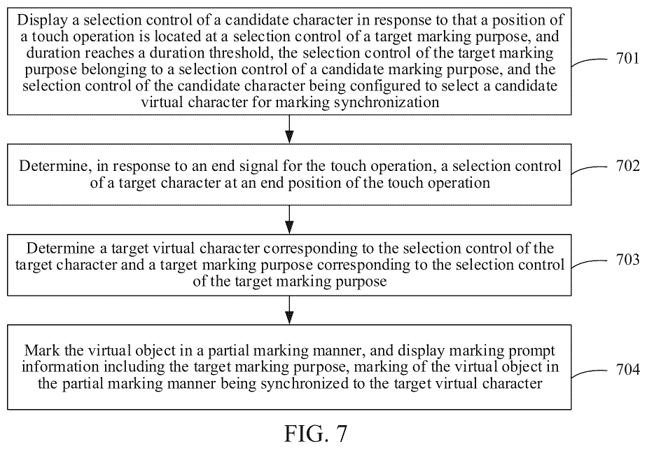

To implement targeted mark synchronization, in the complex marking mode, based on the target marking purpose corresponding to the touch operation, the terminal may only send the target marking purpose to a specific user of an ally team, that is, perform local mark synchronization, to improve precision of the information interaction. FIG. 7 is a flowchart of a local marking method according to an exemplary embodiment of this application. That the method is applied to the terminal shown in FIG. 1 is used as an example for description, and the method may include the following operations.

Operation 701: Display a selection control of a candidate character in response to that a position of a touch operation is located at a selection control of a target marking purpose, and duration reaches a duration threshold, the selection control of the target marking purpose belonging to a selection control of a candidate marking purpose, and the selection control of the candidate character being configured to select a candidate virtual character for marking synchronization.

When in a complex marking mode, a terminal displays a control menu at a position of a virtual object. A user may move a touch position to a display position of the selection control of the target marking purpose, and end the touch operation at the position, to implement the target marking purpose corresponding to the selection control of the target marking purpose. When the user maintains the touch operation at the display position of the selection control of the target marking purpose for specific time, the terminal displays the selection control of the candidate character, so that the user selects the virtual character for the marking synchronization. The user does not need to learn another operation gesture, and may select to enter a local marking mode only by controlling time of the touch operation.

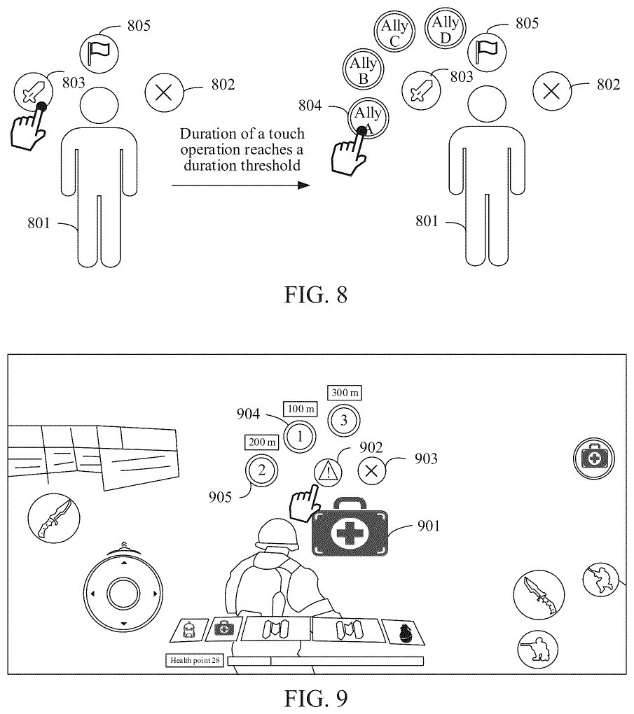

For example, as shown in FIG. 8, a user performs a touch operation at a display position of a virtual object 801, and press force of the touch operation reaches third-level press force. A terminal displays a control menu including a selection control of a candidate marking purpose at the display position of the virtual object based on an object type. The user moves a position of the touch operation to a display position of the selection control of the target marking purpose, for example, an “attack control” 803, and continuously performs the touch operation at the display position of the selection control of the target marking purpose for a duration threshold when press force is maintained to be in third-level press force. In response to that the touch operation satisfies the foregoing conditions, the terminal displays a selection control of a candidate character, for example, an “ally A control” 804. The selection control of the candidate character is configured for the user to select a candidate virtual character for mark synchronization, and the candidate virtual character belongs to a virtual character controlled by the user in an ally team of the user.

In some embodiments, a quantity of selection controls of the candidate character is consistent with a quantity of virtual characters in a survival state currently. In other words, in different battles, the quantity of selection controls of the candidate character may be the same or different. The quantity of selection controls of the candidate character may be the same or different at different battle moments of the same battle.

To improve efficiency of selecting the virtual character, in a possible implementation, based on a correlation between the candidate virtual character and the virtual object, the terminal determines a control position of the selection control of the candidate character corresponding to the candidate virtual character, to display the selection control of the candidate character at the control position. The correlation includes at least one of a character attribute correlation and a distance correlation, and a position priority of the control position is positively correlated with the correlation.

In some embodiments, the position priority of the control position may be determined based on a linear distance between a display position of the control and a display position of the selection control of the target marking purpose, and the position priority is negatively correlated with the linear distance; or may be represented as a matching degree between the display position of the control and a habit degree of a user operation gesture. For example, the user performs the touch operation on a left side of the display region of the terminal. Therefore, a left side of the selection control of the target marking purpose has a higher position priority than a right side of the selection control of the target marking purpose.

In some embodiments, the correlation between the candidate virtual character and the virtual object may include the character attribute correlation. For example, a MOBA game is used as an example. When a character attribute of the virtual object is an output character having a high physical damage, in the battle, an auxiliary virtual character having a gained skill has a higher character correlation with the virtual object in the battle, or when the object type of the virtual object belongs to a virtual item, in the battle, the virtual character having a faster moving speed has a higher character correlation with the virtual object in the battle.

In some embodiments, the correlation between the candidate virtual character and the virtual object may include the distance correlation, to be specific, when the distance between the candidate virtual character and the virtual object is close, there is a high distance correlation between the candidate virtual character and the virtual object.

When the terminal determines the correlation between the candidate virtual character and the virtual object in combination with the distance correlation, and when further determining the control position of the selection control of the candidate character, the terminal may display distance information at the display position of the selection control of the candidate character, to facilitate the user to determine a preferred virtual character.

In an illustrative example, when a duration threshold is one second, and the terminal determines the control position priority of the selection control of the candidate character based on the distance correlation. As shown in FIG. 9, a user performs a touch operation at a “treasure box” 901 display position, and press force of the touch operation reaches third-level press force. A terminal is in a complex marking mode, and the terminal displays, based on that a virtual object “treasure box” belongs to a virtual item, a control menu including an attention control 902 and a cancel control 903. Therefore, when the user moves a position of the touch operation to the attention control 902 for duration of one second, the terminal determines, based on that a “teammate 1” controlled by the user in an ally team is closest to the virtual object, the terminal determines that a selection control 904 of a candidate character corresponding to a “teammate 1A” has a highest position priority, that is, the control is displayed at a position at a shortest linear distance from a selection control 902 of a target marking purpose. Similarly, when a “teammate 2” controlled by the user in the ally team is only farther from the virtual object than the “teammate 1”, the terminal determines that a selection control 905 of the candidate character corresponding to the “teammate 2” has a second position priority. The rest can be deduced by analogy.

In another embodiment, the terminal may determine a control position priority based on both a distance correlation and a character attribute correlation. The distance correlation and the character attribute correlation may correspond to a same priority impact factor or may correspond to different priority impact factors. This is not limited in this embodiment of this application.

Operation 702: Determine, in response to an end signal for the touch operation, a selection control of a target character at an end position of the touch operation.

This operation is the same as operation 402. The user may select the selection control of the target character by moving the position of the touch operation to the display position of the selection control of the candidate character, and ending the touch operation at the position.

In a possible implementation, in response to the end signal of the touch operation, the terminal detects a coordinate point at which the touch operation ends, and determines the selection control of the candidate character displayed at the coordinate point, to determine that the selection control of the candidate character is the selection control of the target character.

Operation 703: Determine a target virtual character corresponding to the selection control of the target character and a target marking purpose corresponding to the selection control of the target marking purpose.

It can be learned from operation 702 that, the terminal determines the selection control of the target character, and then the terminal determines, based on a mapping relationship between the selection control of the candidate character and the virtual character, a virtual character corresponding to the selection control of the target character, and the target virtual character is the virtual character controlled by the user in the ally team. The terminal determines, based on the position of the touch operation, that duration of the selection control of the candidate marking purpose reaches a duration threshold, that the selection control of the candidate marking purpose is the selection control of the target marking purpose, and then the terminal determines the target marking purpose based on a mapping relationship between a selection control of a marking purpose and the marking purpose.

In some embodiments, the terminal may display the selection control of the candidate character including a character identifier of the virtual character. The character identifier of the virtual character is an identifying pattern that may represent the virtual character corresponding to the selection control of the candidate character. For example, the selection control of the virtual character may be a virtual character drawing, a name, a code number, or the like, or may be a nickname of the user controlling the virtual character. This is not limited in this application.

In an illustrative example, the MOBA game is used as an example. As shown in FIG. 8, the user performs the touch operation on a virtual character controlled by the user in an enemy team. In the complex marking mode, the terminal displays the control menu including the “attack control” 803, an “assemble control” 805, and the “cancel control” 802. When the user expects that marking information for attacking the virtual character is synchronized to a virtual character “ally A” controlled by the user in the ally team, the user may first move the touch position to the selection control of the target marking purpose, that is, a display position of the “attack control” 803. The terminal determines, in response to that duration of the touch position during the “attack control” 803 reaches a duration threshold of one second, that the target marking purpose is “attack”. In addition, the terminal displays the selection control of the candidate character including an “ally A control” 804, so that the user may move the touch position to the “ally A control” 804. The terminal determines, in response to that the touch operation ends at a display position of the “ally A control” 804, that the target virtual character for mark synchronization is the “ally A”.

Operation 704: Mark the virtual object in a partial marking manner, and display marking prompt information including the target marking purpose, marking of the virtual object in the partial marking manner being synchronized to the target virtual character.

The terminal may perform local marking based on the target virtual character. In the local marking, the terminal only performs mark synchronization to only some virtual characters in the same team of virtual characters. In a possible implementation, the terminal synchronizes a mark including the marking purpose to the target virtual character, and displays marking prompt information including the target marking purpose on the corresponding terminal. For example, the MOBA game is used as an example. The terminal determines that the “character A” is the target virtual character, and the selection control of the target marking purpose is the “attack” control. The terminal synchronizes the “attack” mark to the “character A” in response to the end signal of the touch operation, and displays a corresponding “attack” prompt.

In conclusion, the user may synchronize the mark including the marking purpose to a specified virtual character by selecting the target virtual object, to facilitate the virtual character to perform the operation conveyed by the marking purpose. In addition, remaining virtual characters are not affected by the marking operation. Therefore, precision of interaction is improved, a possibility of mis-transmission of the marking information is reduced, and information interaction efficiency is improved.

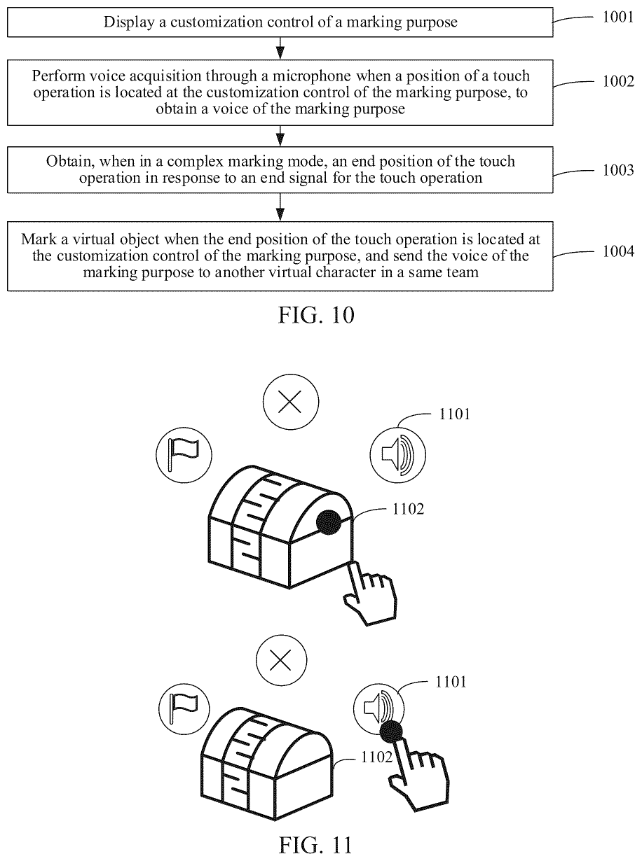

In the foregoing embodiment, when in the complex marking mode, when the marking purpose is selected based on a fixed selection control of the candidate marking purpose, a selection control of the marking purpose by the user is limited by a quantity of selection controls of the candidate marking purpose. During the battle, the user usually needs to perform more complex information interaction. In the foregoing situation, the user may convey a customization marking purpose through a customization control of the marking purpose displayed in the complex marking mode. FIG. 10 is a flowchart of a customization marking method according to an exemplary embodiment of this application. That the method is applied to the terminal shown in FIG. 1 is used as an example for description, and the method may include the following operations.

Operation 1001: Display a customization control of a marking purpose.

A terminal determines a selection control of a candidate marking purpose through a material provided by a server. Therefore, the selection control of the candidate marking purpose that may be selected is limited, and cannot satisfy an interaction requirement of a user in a complex virtual battle. In addition, in a possible situation, there may be common and convenient communication terms between users according to rules of a game. The common and convenient communication terms have a high probability of existing in a battle and are more consistent with communication habits of the user. To improve information interaction efficiency, the user may customize the marking purpose through the customization control of the marking purpose.

When in a complex marking mode, the terminal displays a control menu including a selection control of a candidate marking purpose. In a possible implementation, as shown in FIG. 11, a terminal displays a customization control 1101 of a marking purpose in a control menu.

Operation 1002: Perform voice acquisition through a microphone when a position of a touch operation is located at the customization control of the marking purpose, to obtain a voice of the marking purpose.

The terminal displays the customization control of the marking purpose in the control menu. A manner that a user customizes the marking purpose through the customization control of the marking purpose may be that the user moves a touch position to a display position of the customization control of the marking purpose. In response to that a coordinate point of the touch position detected by the terminal is located at the display position of the customization control of the marking purpose, the terminal activates a recording mode and acquires voice of the user through the microphone. In other words, the user may convey the marking purpose in a voice manner. When flexibility of marking content is improved, the user does not need to perform a complex gesture operation. Therefore, an impact of a marking process on operations such as controlling the user and fighting is reduced.

In an illustrative example, a MOBA game is used as an example. As shown in FIG. 11, when the user expects to inform an ally team that a virtual object “treasure box” 1102 needs to be obtained with three people cooperation, only information that the touch operation is performed, an attention mark is sent, and three virtual object is needed for cooperation is displayed on the “treasure box” 1102. The user may move a touch position to a display position of a customization control 1101 of a marking purpose in a complex marking mode, and continue for one second when press force is maintained. In response to that a terminal detects that a coordinate point of the touch operation is at the display position of the customization control 1101 of the marking purpose, the terminal activates a recording mode, obtains a voice of the user “three people are needed to open the treasure box” through a microphone, stores voice data, to obtain a voice of the marking purpose.

Operation 1003: Obtain, when in the complex marking mode, an end position of a touch operation in response to an end signal for the touch operation.

In the complex marking mode, the terminal displays a control menu. The control menu includes a plurality of selection controls of the candidate marking purpose, a cancel control, and the customization control of the marking purpose. The user selects an execution function by moving the touch position to a display position of a target selection control, and ending the touch operation at the position. Further, in a possible implementation, the terminal detects an end position of the touch operation in response to the end signal of the touch operation, to determine the target selection control. The target selection control is a control displayed at the end position of the touch operation.

Operation 1004: Mark a virtual object when the end position of the touch operation is located at the customization control of the marking purpose, and send the voice of the marking purpose to another virtual character in a same team.

In some embodiments, the terminal may mark the virtual object in a global manner or a local manner. Correspondingly, the voice of the marking purpose may be synchronized to all virtual characters or some virtual characters in the same team. When the partial marking manner is used, the terminal may display the selection control of the candidate character for the user to select by using the solution provided in the foregoing embodiments. Details are not described herein in this embodiment.

In a possible implementation, the terminal determines the end position of the touch operation. When the end position of the touch operation is located at the display position of the customization control of the marking purpose, the terminal determines a marking manner corresponding to the customization control of the marking purpose, and plays the voice of the marking purposes. When the user performs marking in the global marking manner, the terminal synchronizes the mark to another virtual character in an ally team.

In a possible implementation, in response to that the end position of the touch operation is located at the customization control of the marking purpose, the terminal transmits the stored voice data of the marking purpose to a user terminal in the ally team through a server, and the user plays the voice data.

In conclusion, when in the complex marking mode, the user may flexibly set a marking purpose through the customization control of the marking purpose and through a single touch operation, and synchronize a corresponding mark with the virtual character in the ally team. In addition, the user does not need to master a new touch operation mode, so that the operation is simple and convenient, the marking purpose is enriched, and information interaction efficiency and marking accuracy are improved.

Based on the foregoing embodiments of this application, the marking mode is determined based on the press force of the touch operation in this solution. In addition, the marking manner is determined. Because it is difficult for the user to determine a relationship between the press force of the touch operation and the marking mode, during a battle, the user may switch the marking mode by adjusting touch force, and the terminal feeds back the current marking mode to the user through vibration feedback and visual feedback, so that a mis-operation is reduced.

In some embodiments, when the press force changes and a mode switching condition is satisfied, the terminal switches the marking mode.

In the single touch operation, the user may switch the marking mode by adjusting the press force of the touch operation. In a possible implementation, the mode switching condition includes at least a press threshold. When the press force reaches the press threshold, the terminal switches the marking mode in response to the touch operation. Because the press force is not easy to control in an actual operation, to avoid mis-switching, a protection interval of the press force is set for a difference between press levels. A setting manner for setting the protection interval of the press force may be to set a first threshold and a second threshold respectively. A press region between the first threshold and the second threshold is the protection interval of the press force.

In an i^{th} marking mode, an (i+1)^{th} marking mode is used through switching when the press force is increased and the press force reaches the first threshold, i being a positive integer. When the press force of the touch operation gradually increases, the terminal uses the first threshold as the mode switching condition.

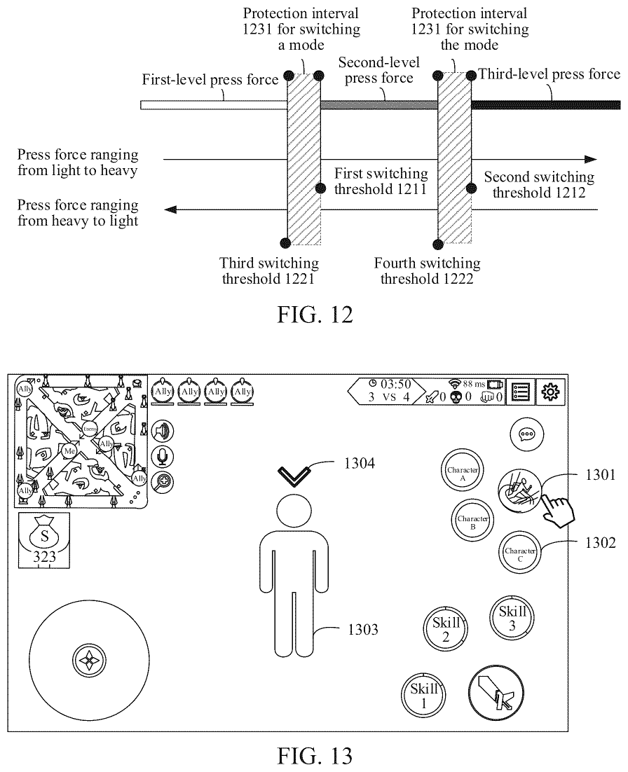

As shown in FIG. 12, for example, when currently in a first marking mode, as the press force increases, when the press force reaches a first switching threshold 1211 (belonging to the first threshold), for example, 1 N, a change of the press force satisfies a mode switching condition, and a marking mode is switched from the first marking mode to a second marking mode. When currently in the second marking mode, as the press force increases, when the press force reaches a second switching threshold 1212 (belonging to the first threshold), for example, 3 N, the change of the press force satisfies the mode switching condition, and the marking mode is switched from the second marking mode to a third marking mode.

In an (i+1)^{th} marking mode, an i^{th} marking mode is used through switching when the press force is decreased, and the press force reaches a second threshold, the second threshold being less than the first threshold. When the press force of the touch operation gradually decreases, the terminal uses the second threshold as the mode switching condition.

As shown in FIG. 12, for example, when currently in the second marking mode, as the press force decreases, when the press force reaches a third switching threshold 1221, for example, 1.5 N, the change of the press force satisfies the mode switching condition, and the marking mode is switched from the second marking mode to the first marking mode. When currently in the third marking mode, as the press force decreases, when the press force reaches a fourth switching threshold 1222, for example, 2.5 N, the change of the press force satisfies the mode switching condition, and the marking mode is switched from the third marking mode to the second marking mode. Because the second threshold is less than the first threshold, there is a specific press force range between two mode switching conditions, that is, a protection interval 1231 of the press force. Therefore, the press force range corresponding to the marking mode is widened, a probability of mis-operation is reduced, and a difficulty of the marking operation is further degraded. Further, in a possible implementation, the terminal may prompt the user through the vibration feedback that the marking mode is switched, to reduce the possibility of the mis-operation. The terminal may perform the vibration feedback based on a feedback manner corresponding to a switched marking mode, a vibration degree of the vibration feedback being positively correlated with press force for triggering to enter the switched marking mode.

In conclusion, the terminal supports the user to switch the marking mode during a same press operation, and the user only needs to adjust the press force to switch the marking mode. Therefore, the operation is simple. In addition, the terminal sets the protection interval of the press force by setting two different press force thresholds corresponding to different switching directions. Therefore, impact of the control of the user over the press on the probability of the mis-operation is reduced, and the probability of the mis-operation is reduced.

Because the virtual character may all move during the battle, when a marking virtual object of the user is a moving virtual object, there is a specific operation difficulty in marking the moving virtual object through the touch operation. To reduce a difficulty of marking a moving virtual object, in a possible implementation, the terminal may display a dynamic marking control. The user may perform a triggering operation on the dynamic marking control. In response to the triggering operation, the terminal displays a plurality of candidate marking object controls. Therefore, the user may perform the press operation in the foregoing embodiments on the candidate marking object control, to accurately mark the virtual object in a moving state. The following provides descriptions with reference to an exemplary embodiment.

1. Display a candidate marking object control in response to a triggering operation for a dynamic marking control, different candidate marking object controls corresponding to different virtual objects in a motion state.

In a virtual battle, a virtual character is generally in a moving state. If the virtual object in the motion state is marked through the touch operation in the foregoing embodiments of this application, there is a high probability of a failed operation. To accurately mark the moving virtual object, the terminal may display the candidate marking object control. The candidate marking object control has a mapping relationship with the virtual object in the motion state. A user may perform marking by performing the touch operation on a target marking object control in the candidate marking object control, to reduce a probability of marking failure.

In a possible implementation, as shown in FIG. 13, a dynamic marking control 1301 is displayed in a terminal. The dynamic marking control is configured to start a dynamic marking mode. In response to a triggering operation on the dynamic marking control, the terminal detects positions and motion features of virtual objects, and determines a virtual object that is currently in a motion state. Then, the terminal displays an object control 1302 corresponding to the virtual object in the motion state based on a mapping relationship between the virtual object and an object control, that is, a candidate marking object control.

In some embodiments, the virtual object corresponding to the candidate marking object control may only include a moving virtual object in a current field of view of the user, or may be a moving virtual object in a global range.

2. Receive a touch operation for the candidate marking object control.

In this embodiment of this application, the user may mark the corresponding virtual object by performing the touch operation on the candidate marking object control, and the terminal receives the touch operation for the candidate marking object control. Same as the foregoing embodiments, the terminal determines a marking mode based on press force of the touch operation.

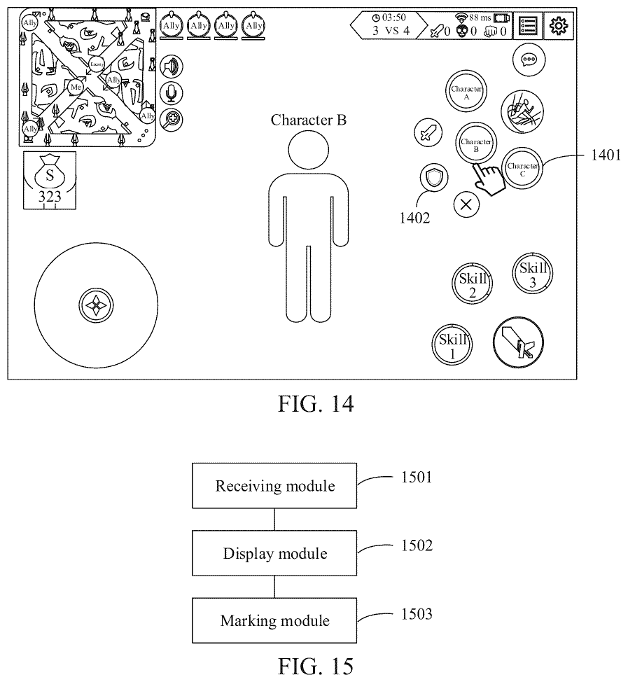

In a possible implementation, when the terminal is in the dynamic marking mode, the terminal detects a position of the touch operation. Based on that the position of the touch operation is a display position of the candidate marking object control, the terminal receives the touch operation and detects the press force of the touch operation, and then enters the corresponding marking mode based on the press force. As shown in FIG. 13, when in a simple marking mode, in response to that the position of the touch operation is located at the target marking object control, the terminal may display a marking preview 1304 at a position corresponding to an object control 1302 of the target mark and a virtual object 1303. For example, a MOBA game is used as an example. A user performs a touch operation with first-level of press force on the target marking object control of a “character A”. In response to the touch operation, an arrow icon is displayed at a position of the virtual object “character A” in the terminal, to implement the marking preview. When in the complex marking mode, as shown in FIG. 14, in response to that the position of the touch operation is located at an object control 1401 of the target mark, the terminal may display a selection control 1402 of a candidate marking purpose at the position of the target marking object control, so that the user selects the selection control of the target marking purpose.

In conclusion, when the user expects to mark the virtual object in the motion state, the user may trigger the dynamic marking control to invoke a control menu of a candidate marking object, and perform the touch operation on the candidate marking object control, to mark the corresponding virtual object. In this embodiment of this application, the dynamic marking control is displayed on the terminal, and the terminal converts a process for marking the moving virtual object into a process for marking a stationary candidate marking object control. Therefore, marking accuracy is improved, and a marking difficulty is reduced.

FIG. 15 is a structural block diagram of an apparatus for marking a virtual object according to an exemplary embodiment of this application. The apparatus includes:
a receiving module 1501, configured to receive a touch operation for a virtual object;
a display module 1502, configured to display a marking mode prompt, the marking mode prompt being configured for indicating a marking mode currently used for marking the virtual object, and different force of the touch operation corresponding to different marking modes; and
a marking module 1503, configured to: mark, when the marking mode is a target marking mode, the virtual object by using the target marking mode in response to an end signal for the touch operation.

In some embodiments, the display module 1502 is configured to:
determine the marking mode based on press force of the touch operation; and
display a simple marking mode prompt when the marking mode belongs to a simple marking mode, the simple marking mode being a marking mode that does not support conveying a marking purpose; or
display a complex marking mode prompt when the marking mode belongs to a complex marking mode, the complex marking mode being a marking mode that supports conveying a marking purpose.

In some embodiments, the displaying a complex marking mode prompt when the marking mode belongs to a complex marking mode, the display module 1502 is further configured to:
determine an object type of the virtual object when the marking mode belongs to the complex marking mode, the object type including at least one of a virtual character, a virtual item, and a virtual position;
determine a candidate marking purpose of the virtual object based on the object type, different object types corresponding to different candidate marking purposes; and
display a selection control of the candidate marking purpose corresponding to the candidate marking purpose.

In some embodiments, when the target marking mode is the complex marking mode, the marking module 1503 is configured to:
determine, in response to the end signal for the touch operation, a selection control of a target marking purpose located at an end position of the touch operation, the selection control of the target marking purpose belonging to the selection control of the candidate marking purpose;
determine a target marking purpose corresponding to the selection control of the target marking purpose; and
mark the virtual object in a global marking manner, and display marking prompt information including the target marking purpose, marking of the virtual object in the global marking manner is synchronized to another virtual character in a same team.

In some embodiments, when the target marking mode is the complex marking mode, the display module 1502 is further configured to:
display a selection control of a candidate character in response to that a position of the touch operation is located at a selection control of a target marking purpose, and duration reaches a duration threshold, the selection control of the target marking purpose belonging to the selection control of the candidate marking purpose, and the selection control of the candidate character being configured to select a candidate virtual character for marking synchronization; and
the mark module 1503 is further configured to:
determine, in response to the end signal for the touch operation, a selection control of a target character at an end position of the touch operation;
determine a target virtual character corresponding to the selection control of the target character and a target marking purpose corresponding to the selection control of the target marking purpose; and
mark the virtual object in a partial marking manner, and display marking prompt information including the target marking purpose, marking of the virtual object in the partial marking manner is synchronized to the target virtual character.

In some embodiments, when a selection control of a candidate character is displayed, the display module 1502 is further configured to:
determine a control position of the selection control of the candidate character corresponding to the candidate virtual character based on a correlation between the candidate virtual character and the virtual object, the correlation including at least one of a character attribute correlation and a distance correlation, and a position priority of the control position being positively correlated with the correlation; and
display the selection control of the candidate character at the control position.

In some embodiments, the display module 1502 is configured to:
display a customization control of the marking purpose; and
the mark module 1503 is configured to:
perform voice acquisition through a microphone when the position of the touch operation is located at the customization control of the marking purpose, to obtain a voice of the marking purpose;
obtain the end position of the touch operation in response to the end signal for the touch operation when the target marking mode is the complex marking mode; and
mark the virtual object when the end position of the touch operation is located at the customization control of the marking purpose, and send the voice of the marking purpose to the another virtual character in the same team.

In some embodiments, when the marking mode belongs to the simple marking mode, and the simple marking mode prompt is displayed, the marking module 1503 is configured to:
perform a marking effect preview based on a marking manner corresponding to the marking mode when the marking mode belongs to the simple marking mode,
a marking manner corresponding to the simple marking mode including a local marking manner and a global marking manner, the marking for the virtual object in the local marking manner being locally applied, and the marking of the virtual object in the global marking manner being synchronized to another virtual character in a same team.

In some embodiments, the receiving module 1501 is configured to that
press force for triggering to enter the simple marking mode is less than press force for triggering to enter the complex marking mode.

In some embodiments, the mark module 1503 is configured to:
switch the marking mode when the press force changes and a mode switching condition is satisfied;
switching to an (i+1)^{th} marking mode in an i^{th} marking mode when the press force is increased and the press force reaches a first threshold;
switching to the it marking mode in the (i+1)^{th} marking mode when the press force is decreased, and the press force reaches a second threshold, the second threshold being less than the first threshold; and
perform vibration feedback based on a feedback manner corresponding to a switched marking mode, a vibration degree of the vibration feedback being positively correlated with press force for triggering to enter the switched marking mode.

In some embodiments, the display module 1502 is configured to:
display a candidate marking object control in response to a triggering operation for a dynamic marking control, different candidate marking object controls corresponding to different virtual objects in a motion state; and
the receiving module 1501 is configured to
receive a touch operation for the candidate marking object control.

In some embodiments, the mark module 1503 is further configured to
perform vibration feedback based on a feedback manner corresponding to the target marking mode, a vibration degree of the vibration feedback being positively correlated with press force for triggering to enter the target marking mode.

In conclusion, in this embodiment of this application, the terminal receives the touch operation through the receiving module, and then, determines the press force of the touch operation. Based on the press force of the touch operation, the display module determines the current marking mode, and displays the marking mode prompt, such as the simple marking mode prompt and the complex marking mode prompt, to prompt the current marking mode to the user. In the complex marking mode, the display module determines the candidate marking purpose based on the object type of the virtual object, and displays the corresponding selection control of the candidate marking purpose. In response to the end signal of the touch operation, the mark module determines the selection control of the target marking purpose, and mark the virtual object based on the corresponding target marking purpose. The mark module may mark the virtual object in the global marking manner, the partial marking manner, and the local marking manner and based on different marking modes, and feed back that the marking is completed to the user through the vibration. In this embodiment of this application, the user performs the single touch operation on the virtual object to mark the virtual object. The user performs different marking based on different press force of the touch operation and in one operation manner. Therefore, an operation difficulty is reduced, impact of the mark operation on the control is reduced, and efficiency of the information interaction between users is improved.

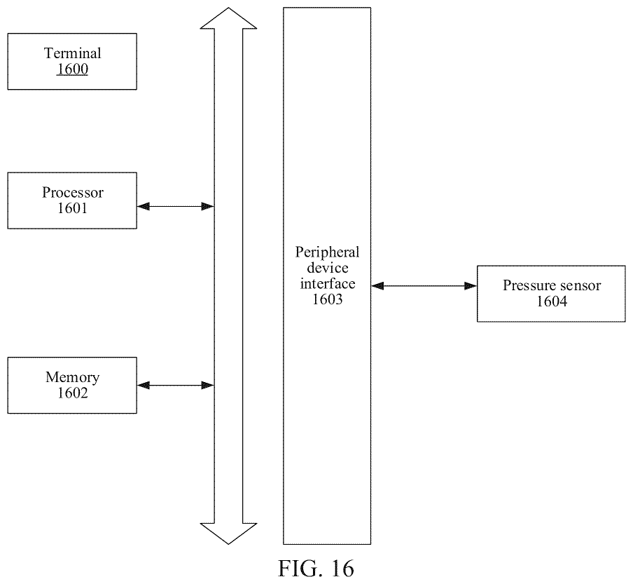

FIG. 16 is a structural block diagram of a terminal 1600 according to an exemplary embodiment of this application. The terminal 1600 may be a portable mobile terminal, such as a smartphone, a tablet computer, a moving picture experts group audio layer III (MP3) player, or a moving picture experts group audio layer IV (MP4) player. The terminal 1600 may also be referred to as another name such as a user device or a portable terminal.

Generally, the terminal 1600 includes a processor 1601 and a memory 1602.

The processor 1601 may include one or more processing cores, such as a 4-core processor and an 8-core processor. The processor 1601 may be implemented in at least one hardware form of a digital signal processor (DSP), a field-programmable gate array (FPGA), and a programmable logic array (PLA). The processor 1601 may also include a main processor and a co-processor. The main processor is a processor configured to process data in an awake state, and is also referred to as a central processing unit (CPU). The co-processor is a low power consumption processor configured to process the data in a standby state. In some embodiments, the processor 1601 may be integrated with a graphics processing unit (GPU). The GPU is configured to render and draw content that needs to be displayed on a display. In some embodiments, the processor 1601 may further include an artificial intelligence (AI) processor. The AI processor is configured to process a computing operation related to machine learning.

The memory 1602 may include one or more computer-readable storage media. The computer-readable storage medium may be tangible and non-transient. The memory 1602 may also include a high-speed random access memory, a nonvolatile memory, such as one or more disk storage devices and flash storage devices. In some embodiments, a non-transitory computer-readable storage medium in the memory 1602 is configured to store at least one instructions, and the at least one instructions are configured to be executed by the processor 1601, to implement the method provided in the embodiments of this application.

In some embodiments, the terminal 1600 further includes a peripheral device interface 1603.

The peripheral device interface 1603 may be configured to connect at least one peripheral devices related to input/output (I/O) to the processor 1601 and the memory 1602. In some embodiments, the processor 1601, the memory 1602, and the peripheral device interface 1603 are integrated on a same chip or a circuit board. In some other embodiments, any one or two of the processor 1601, the memory 1602, and the peripheral device interface 1603 may be implemented on a single chip or the circuit board. This is not limited in this embodiment.

In some embodiments, the terminal 1600 may further include a pressure sensor 1604.

The pressure sensor 1604 is configured to detect press force of a touch operation and send pressure data to the processor 1601. The processor 1601 determines a current marking mode based on the pressure data. The pressure sensor 1604 may be connected to the processor 1601 and the memory 1602 through the peripheral device interface 1603.

The embodiments of this application further provides a computer-readable storage medium, the storage medium storing at least one program, and the at least one program being executed by a processor to implement the method for marking the virtual object according to the foregoing embodiments of this application.

The embodiments of this application further provides a computer program product, the computer program product including computer instructions, and the computer instructions being stored in a computer-readable storage medium. A processor of a computer device reads the computer instructions from the computer-readable storage medium, and the processor executes the computer instructions, so that the computer device executes the method for marking the virtual object provided in the foregoing embodiments of this application.

A person skilled in the art needs to be aware of that in the one or more embodiments, the functions described in the embodiments of this application may be implemented by hardware, software, firmware, or a combination or the above. When implemented by using software, the functions can be stored in a computer readable medium or can be used as one or more instructions or code in a computer readable medium for transferring. The computer-readable medium includes a computer storage medium and a communication medium, the communication medium including any medium that enables a computer program to be transmitted from one place to another. The storage medium may be any available medium accessible to a general-purpose or dedicated computer.

The above mentioned descriptions are merely the optional embodiments of this application, but are not intended to limit this application. Any modification, equivalent replacement, or improvement made without departing from the spirit and principle of this application fall within the protection scope of this application.

What is claimed is:

1. A method for marking a virtual object, performed by a computer device, the method comprising:
receiving a touch operation for a virtual object;
displaying a marking mode prompt in accordance with a current force of the touch operation, the marking mode prompt indicating a marking mode currently used for marking the virtual object at the current force; and
rendering a multi-modal marking on the virtual object in response to an end signal for the touch operation, when the marking mode is a target marking mode.

2. The method according to claim 1, wherein the displaying a marking mode prompt comprises:
determining the marking mode based on the current force of the touch operation;
displaying a first marking mode prompt when the marking mode belongs to a first marking mode that does not support conveying a marking purpose; and
displaying a second marking mode prompt when the marking mode belongs to a second marking mode that supports conveying a marking purpose.

3. The method according to claim 2, wherein the displaying a second marking mode prompt when the marking mode belongs to a second marking mode comprises:
determining an object type of the virtual object when the marking mode belongs to the second marking mode, the object type comprising at least one of a virtual character, a virtual item, and a virtual position;
determining a candidate marking purpose of the virtual object based on the object type; and
displaying a selection control of the candidate marking purpose corresponding to the candidate marking purpose.

4. The method according to claim 3, wherein the displaying a second marking mode prompt when the marking mode belongs to a second marking mode comprises:
displaying a customization control of the marking purpose;
performing voice acquisition through a microphone when the position of the touch operation is located at the customization control of the marking purpose, to obtain a voice of the marking purpose; and
obtaining the end position of the touch operation in response to the end signal for the touch operation; and
rendering the multi-modal marking on the virtual object when the end position of the touch operation is located at the customization control of the marking purpose, and transmitting the voice of the marking purpose to another virtual character.

5. The method according to claim 2, wherein the displaying a first marking mode prompt when the marking mode belongs to a first marking mode comprises:
performing a marking effect preview based on a marking manner corresponding to the marking mode,
the marking manner comprising a local marking manner that limits the marking for the virtual object to the computer device and a global marking manner that synchronizes the marking of the virtual object with another computer device.

6. The method according to claim 1, wherein the method further comprises:
switching the marking mode when the press force changes and a mode switching condition is satisfied before the end signal for the touch operation.

7. The method according to claim 6, wherein the method further comprises:
performing vibration feedback based on a feedback manner corresponding to a switched marking mode, a vibration degree of the vibration feedback being positively correlated with the current force for triggering the switched marking mode.

8. The method according to claim 1, wherein the method further comprises:
displaying a candidate marking object control in response to a triggering operation for a dynamic marking control, different candidate marking object controls corresponding to different virtual objects in a motion state; and
receiving a touch operation for the candidate marking object control.

9. The method according to claim 1, wherein the method further comprises:
performing vibration feedback based on a feedback manner corresponding to the target marking mode, a vibration degree of the vibration feedback being positively correlated with the current force for triggering the target marking mode.

10. A computer device, comprising a processor and a memory, the memory having at least one program stored therein, and the at least one program, when executed by the processor, causing the computer device to perform a method for marking a virtual object including:
receiving a touch operation for a virtual object;
displaying a marking mode prompt in accordance with a current force of the touch operation, the marking mode prompt indicating a marking mode currently used for marking the virtual object at the current force; and
rendering a multi-modal marking on the virtual object in response to an end signal for the touch operation, when the marking mode is a target marking mode.

11. The computer device according to claim 10, wherein the displaying a marking mode prompt comprises:
determining the marking mode based on the current force of the touch operation;
displaying a first marking mode prompt when the marking mode belongs to a first marking mode that does not support conveying a marking purpose; and
displaying a second marking mode prompt when the marking mode belongs to a second marking mode that supports conveying a marking purpose.

12. The computer device according to claim 11, wherein the displaying a second marking mode prompt when the marking mode belongs to a second marking mode comprises:
determining an object type of the virtual object when the marking mode belongs to the second marking mode, the object type comprising at least one of a virtual character, a virtual item, and a virtual position;
determining a candidate marking purpose of the virtual object based on the object type; and
displaying a selection control of the candidate marking purpose corresponding to the candidate marking purpose.

13. The computer device according to claim 12, wherein the displaying a second marking mode prompt when the marking mode belongs to a second marking mode comprises:
displaying a customization control of the marking purpose;
performing voice acquisition through a microphone when the position of the touch operation is located at the customization control of the marking purpose, to obtain a voice of the marking purpose; and
obtaining the end position of the touch operation in response to the end signal for the touch operation; and
rendering the multi-modal marking on the virtual object when the end position of the touch operation is located at the customization control of the marking purpose, and transmitting the voice of the marking purpose to another virtual character.

14. The computer device according to claim 11, wherein the displaying a first marking mode prompt when the marking mode belongs to a first marking mode comprises:
performing a marking effect preview based on a marking manner corresponding to the marking mode,
the marking manner comprising a local marking manner that limits the marking for the virtual object to the computer device and a global marking manner that synchronizes the marking of the virtual object with another computer device.

15. The computer device according to claim 10, wherein the method further comprises:
switching the marking mode when the press force changes and a mode switching condition is satisfied before the end signal for the touch operation.

16. The computer device according to claim 15, wherein the method further comprises:
performing vibration feedback based on a feedback manner corresponding to a switched marking mode, a vibration degree of the vibration feedback being positively correlated with the current force for triggering the switched marking mode.

17. The computer device according to claim 10, wherein the method further comprises:
displaying a candidate marking object control in response to a triggering operation for a dynamic marking control, different candidate marking object controls corresponding to different virtual objects in a motion state; and
receiving a touch operation for the candidate marking object control.

18. The computer device according to claim 10, wherein the method further comprises:
performing vibration feedback based on a feedback manner corresponding to the target marking mode, a vibration degree of the vibration feedback being positively correlated with the current force for triggering the target marking mode.

19. A non-transitory computer-readable storage medium having at least one program stored therein, and the at least one program, when executed by a processor of a computer device, causing the computer device to perform a method for marking a virtual object including:
receiving a touch operation for a virtual object;
displaying a marking mode prompt in accordance with a current force of the touch operation, the marking mode prompt indicating a marking mode currently used for marking the virtual object at the current force; and
rendering a multi-modal marking on the virtual object in response to an end signal for the touch operation, when the marking mode is a target marking mode.

20. The non-transitory computer-readable storage medium according to claim 19, wherein the displaying a marking mode prompt comprises:
determining the marking mode based on the current force of the touch operation;
displaying a first marking mode prompt when the marking mode belongs to a first marking mode that does not support conveying a marking purpose; and
displaying a second marking mode prompt when the marking mode belongs to a second marking mode that supports conveying a marking purpose.
